(19) United States
(12) Patent Application Publication
(10) Pub. No.: US 2003/0030306 A1
(43) Pub. Date: Feb. 13, 2003

(54) Economical sleeping system for aircrafts and vehicles

(76) Inventor: Mark Bogdan Raczkowski, North Miami Beach, FL (US)

Correspondence Address: Lerner & Greenberg PA, PO Box 2480, Hollywood, FL, 33022-2480, US

(21) Appl. No.: 09/927,066

(22) Filed: Aug. 9, 2001

(51) Int. Cl. B60N 2/34; A47C 13/00

(52) U.S. Cl. 297/118; 297/123

(57) ABSTRACT

This invention provides an improved, economical layout for passenger aircraft or other vehicle, including two level convertible sleeping accommodation for passengers at night, and a safety harness for each sleeping person. For day the sleeping accommodation are converted back to an one level, regular seating arrangement.

### CROSS REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO A MICROFICHE APPENDIX

“Not Applicable”

### BACKGROUND OF THE INVENTION

This invention relates to convertible seat and sleeping berth arrangements for passenger vehicles, and has particular reference to such arrangements for passenger aircraft, although the invention is not limited to that use.

Shortcoming in conventional cabin arrangements have been recognized since the beginning of commercial aviation, and many ideas have been advanced to improve passenger accommodations. Unfortunately, many of these designs were deemed to be impractical. Of some interest are: Millar, U.S. Pat. No. 2,775,996; Brandt, U.S. Pat. No. 5,333,818; Daines, U.S. Pat. No. 5,425,516; Ferry, U.S. Pat. No. 6,119,980 and Bar-Levav, U.S. Pat. No. 6,237,872;

Some of prior art require extensive structural changes to an aircraft, other take too much space, or create a usage or maintenance problem.

### BRIEF SUMMARY OF THE INVENTION

An object of this invention is to provide greater physical and emotional comfort to passengers during long intercontinental and transcontinental journeys, without reducing the number of seats in the aircraft, thus maintaining a reasonable price structure. Repeated opinion surveys confirm that almost universally the single most important feature desired by passengers during long travel is the ability to stretch out for resting or sleeping. The present invention achieves this feature by raising every second seat and converting lower and upper seats to berths for comfortable night sleeping. The upper berths are equipped with coiled ladders, and each berth has a safety harness for a sleeping person. The raising seats are moved up or down by built-in jacking or lifting devices. This invention does not require any structural changes to an airplane or vehicle, only existing seats have to be replaced by the convertible and raised convertible seats and sleeping berths of this invention.

The above objects and other advantages of the present invention will be readily apparent from the following detailed description taken in conjunction with the accompanying drawings.

### BRIEF DESCRIPTION OF THE DRAWINGS

FIG. 1 is a side view of a raised convertible seat and sleeping berth, with built in jacking device, in a down position and without a right arm rest.

FIG. 2 is a side view of a raised convertible seat and sleeping berth from FIG. 1 in a raised and reclined for sleeping position, without a right arm rest.

FIG. 3 is a front view of the raised convertible seat and sleeping berth from FIG. 1 in a down and seating position.

FIG. 4 is a side view of a raised convertible seat and sleeping berth with built in lifting device, in a down and sitting position.

FIG. 5 is a side view of a raised convertible seat and sleeping berth from FIG. 4 in an upper, reclined and sleeping position.

FIG. 6 is a front view of a raised convertible seat and sleeping berth from FIG. 5, in an upper and sleeping position.

FIG. 7 is a side view of a raised convertible seat and sleeping berth with a guiding column in a seating and down position.

FIG. 8 is a side view of a raised convertible seat and sleeping berth from FIG. 7 in an upper and sleeping position.

FIG. 9 is a front view of a raised convertible seat and sleeping berth from FIG. 8 in an upper and sleeping position.

FIG. 10 is a side view of a convertible seat and sleeping berth in a seating position.

FIG. 11 is a side view of a convertible seat and sleeping berth from FIG. 10 in a sleeping position.

FIG. 12 is a front view of a convertible seat and sleeping berth from FIG. 10 in a seating position.

FIG. 13 is a side view of a line of convertible seats and sleeping berths, and raised convertible seats and sleeping berths with jacking devices, all in seating positions.

FIG. 14 is a side view of a line of seats and sleeping berths from FIG. 13, but all of them in a sleeping position. The raised convertible seats with sleeping berths are shown reclined in their upper positions.

FIG. 15 is a side view of a line of convertible seats and sleeping berths, and raised convertible seats and sleeping berths with lifting devices, all in a seating position.

FIG. 16 is a side view of a line of seats and sleeping berths from FIG. 15, but all in sleeping position. The raised convertible seats with sleeping berths are shown reclined in their upper position.

FIG. 17 is an axonometric view of a safety harness for a sleeping person.

FIG. 18 is a plan view of the 747 aircraft with its seating arrangement.

### DETAILED DESCRIPTION OF THE INVENTION

The present invention is an improvement to utilization of very valuable space in aircrafts, trains, buses and in other vehicles. Some elements used in this invention are very well known, like: Convertible seats and beds, jacking and lifting devices, etc., so they will not be described in great details in this specification.

Also there are many kinds of jacking and lifting devices, like: Manual, foot operated, mechanical, electric, pneumatic, hydraulic etc. Many of them could be used to raise seats of this invention, so they also will not be described in great details over here.

The present invention will now be described in details with reference to the accompanying drawings.

FIG. 1 shows a side view of the raised convertible seat and sleeping berth 1, without a right rest arm, in a seating position. There is also a backrest 2, a base frame 3, a jacking device 4, a sliding support 5, a seat panel 6, a rotational leg rest 7 ,and a front axel 8; Also there is visible a left arm rest 9 and a rear axel 10.

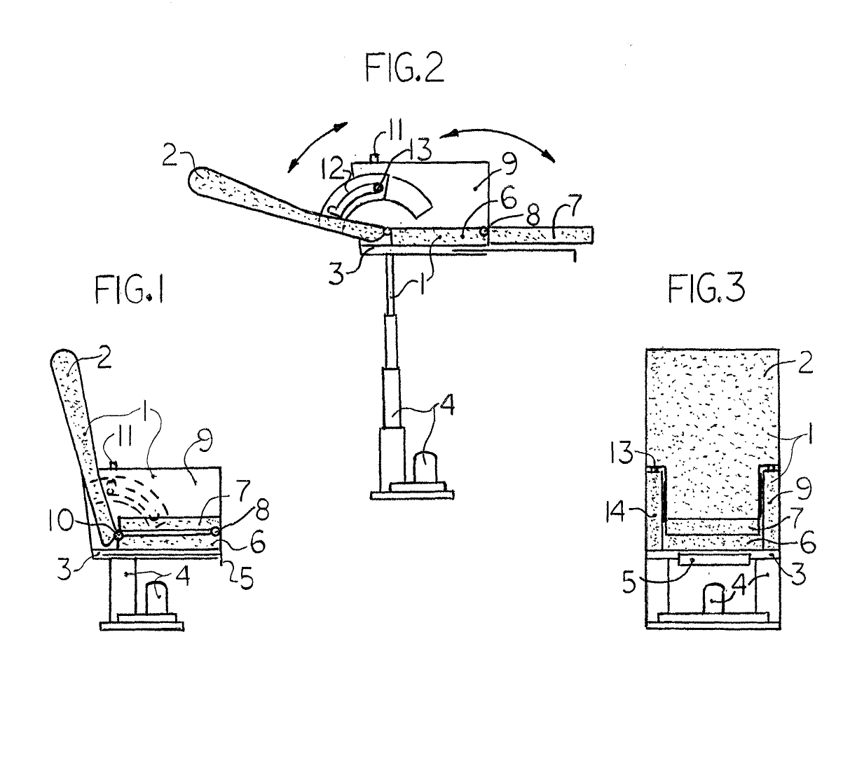

FIG. 2 shows a side view of the raised convertible seat and sleeping berth 1 from FIG. 1 in a sleeping position. The backrest 2 is rotated around the rear axle 10 to an almost horizontal position. There is visible a hinge assembly with a position lock 12 and an up-down bolt 13. The hinge 12 is attached to a side of the backrest 2, and the up-down bolt 13 is attached to the left arm rest 9. In the backrest low position the hinge 12 is held in place by the up-down bolt 13. In the seating position the backrest with its hinge 12 is held in place by the bolt 13 moved to upper position by a hidden spring. In order to release the backrest from upper to a low position, a push button 11 has to be pushed down in order to lower the up-down bolt 13 and to release the hinge 12 to rotate down. The leg rest 7 is rotated around the axel 8 to its night position, and the sliding support 5 has to be slide out. The jacking devices 4 are remotely controlled by the aircraft crew. FIG. 3 shows a front view of the raised convertible seat and sleeping berth from FIG. 1 in a down and sitting position.

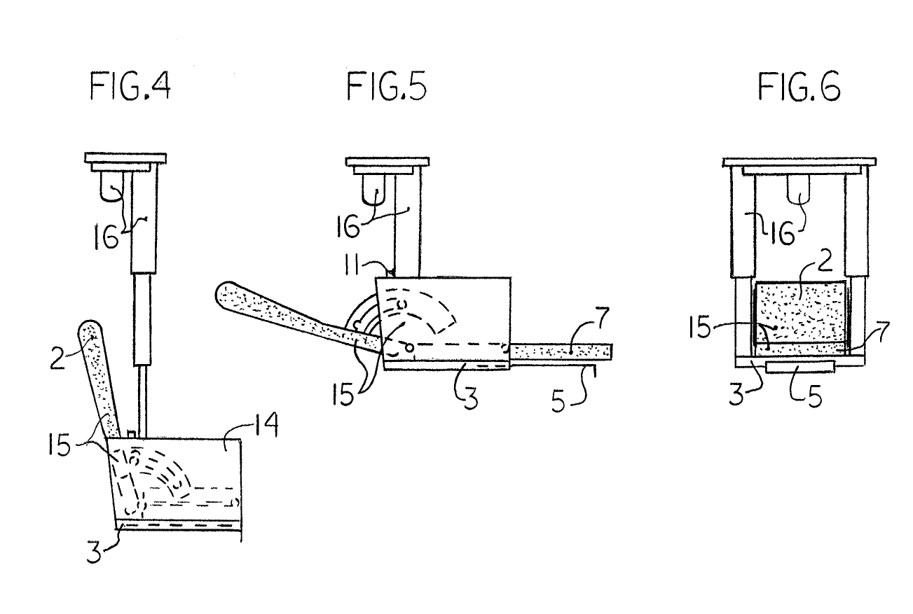

FIG. 4 shows a side view of the raised convertible seat and sleeping berth 15 with a lifting device in a low and seating position. There is also visible a lifting device 16 and a right arm rest 14. Other parts are the same as in FIG. 1.

FIG. 5 shows a side view of the raised convertible seat and berth from FIG. 4 in a raised and sleeping position. Except the lifting device 16, other parts are similar to FIG. 2. FIG. 6 shows a front view of the raised convertible seat and sleeping berth 15 from the FIG. 5.

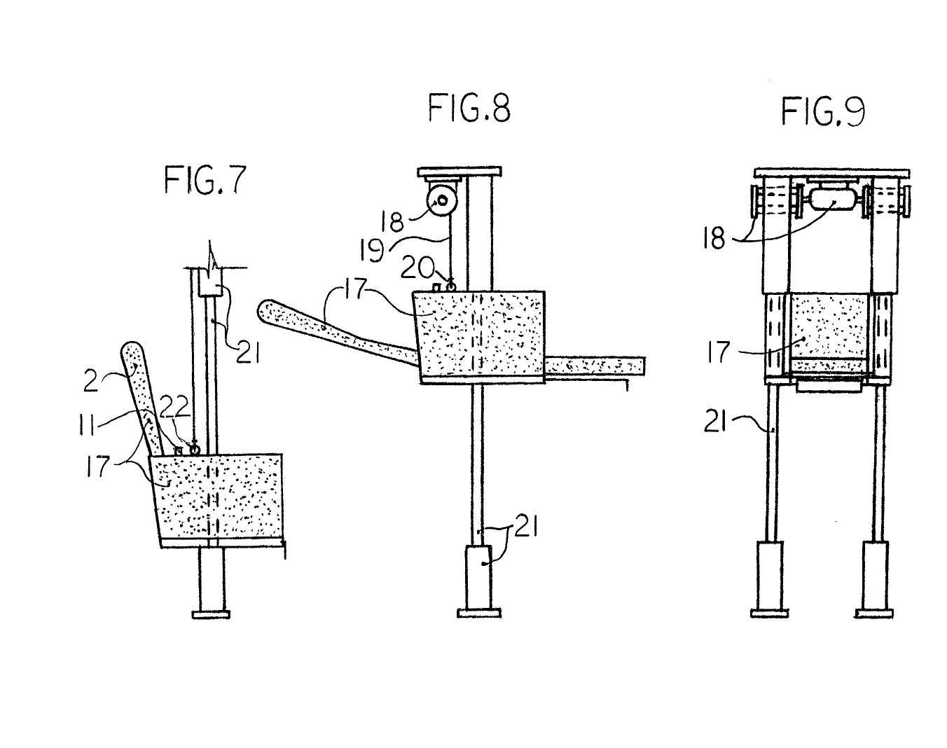

FIG. 7 shows a side view of a raised convertible seat and sleeping berth 17 in a down and seating position. There is visible a backrest 2, a push button 11, a guiding column 21 and a seat's ring 22.

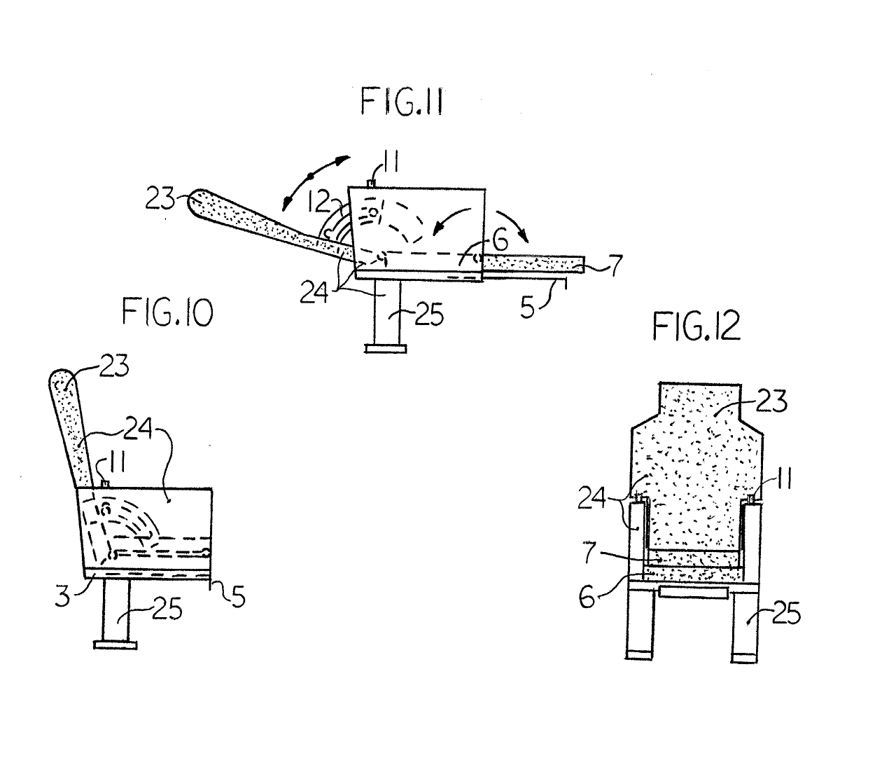

FIG. 8 shows side view of the raised convertible seat and sleeping berth 17 from FIG. 7 in an upper, reclined and sleeping position. There is also shown a hoist lift 18, a cable 19 with a hook 20 engaged with a seat's ring 22 and a coiled ladder 26.

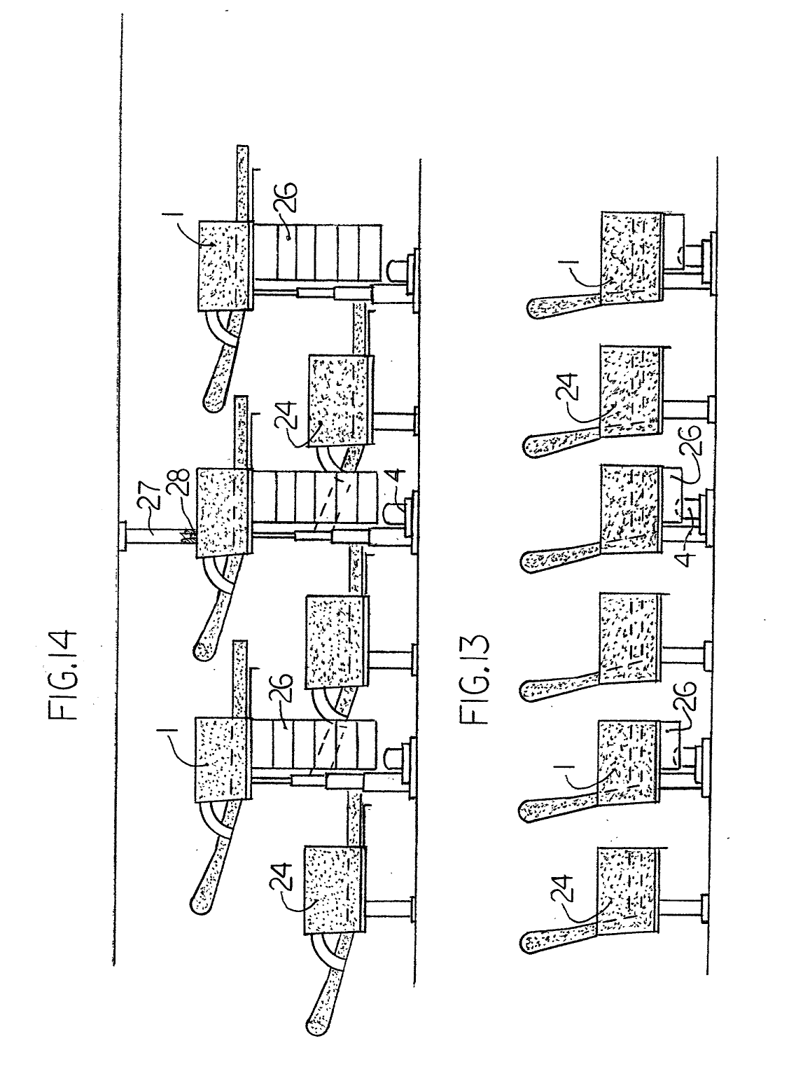

FIG. 9 shows a front view of the raised convertible seat and sleeping berth 17 from FIG. 8 in an upper, reclined and sleeping position.

FIG. 10 shows a side view of a convertible seat and sleeping berth 24 in a seating position. There is seen a base frame 3, a sliding support 5, a push button 11, a backrest 23 and a leg 25.

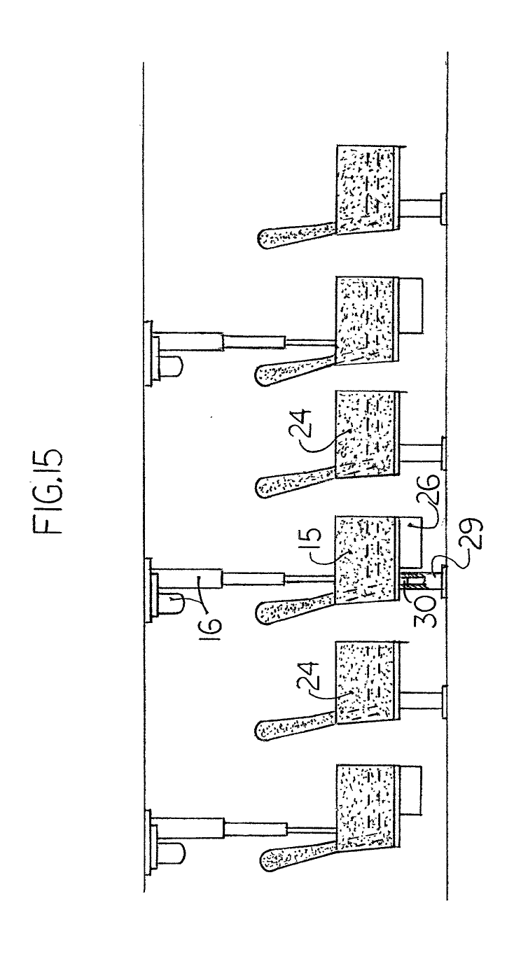

FIG. 11 shows a side view of the convertible seat and sleeping berth 24 from FIG. 10 in a reclined and sleeping position.

FIG. 12 shows a front view of the convertible seat and sleeping berth 24 from FIG. 10.

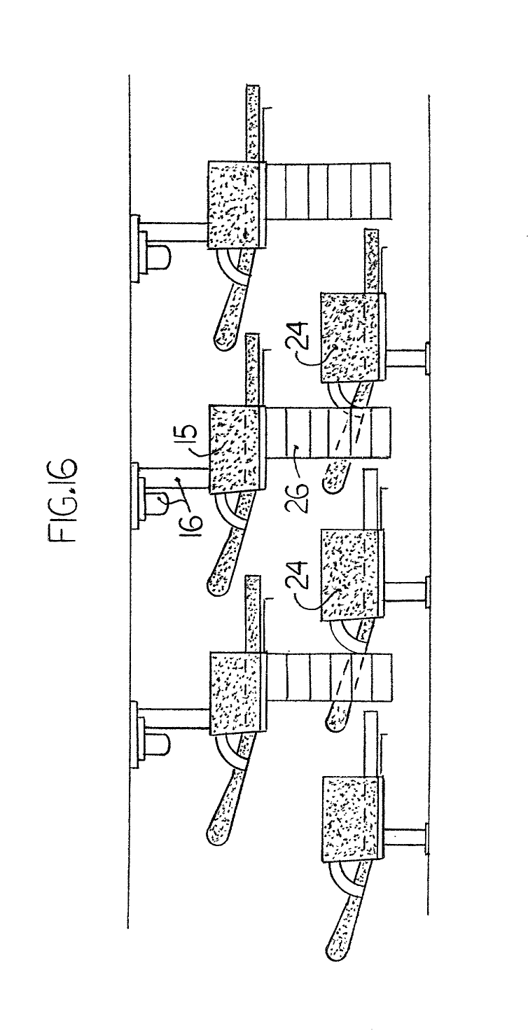

FIG. 13 shows a line of the convertible seats and sleeping berths 24 and the raised convertible seats and sleeping berths 1 with jacking devices 4 and with coiled ladders 26, standing behind each other, and all of them in a down and seating position.

FIG. 14 shows the same raised and convertible seats and sleeping berths from FIG. 13, but in a sleeping position. The raised convertible seats and sleeping berths 1 are in their upper positions. Also a ceiling support 27 with engaged seat's insert 28 is shown.

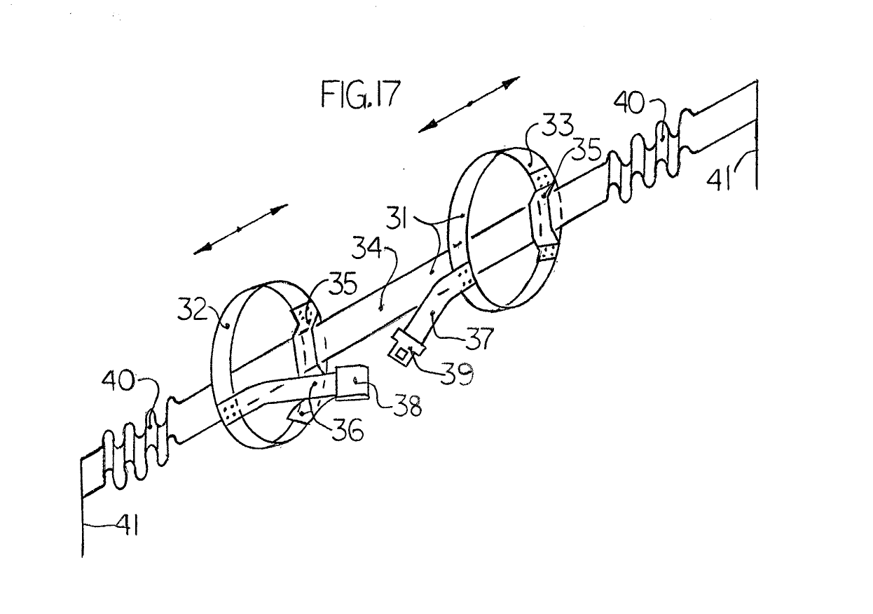

FIG. 15 shows a line of the raised convertible seats and sleeping berths 15 and the convertible seats and sleeping berths 24, standing behind each other, in their down and seating position. Also visible are lifting devices 16 and coiled ladders 26.

FIG. 16 shows the raised convertible seats and sleeping berths 15 in an upper position and the convertible seats and sleeping berths 24 from FIG. 15, but all of them in reclined and sleeping position.

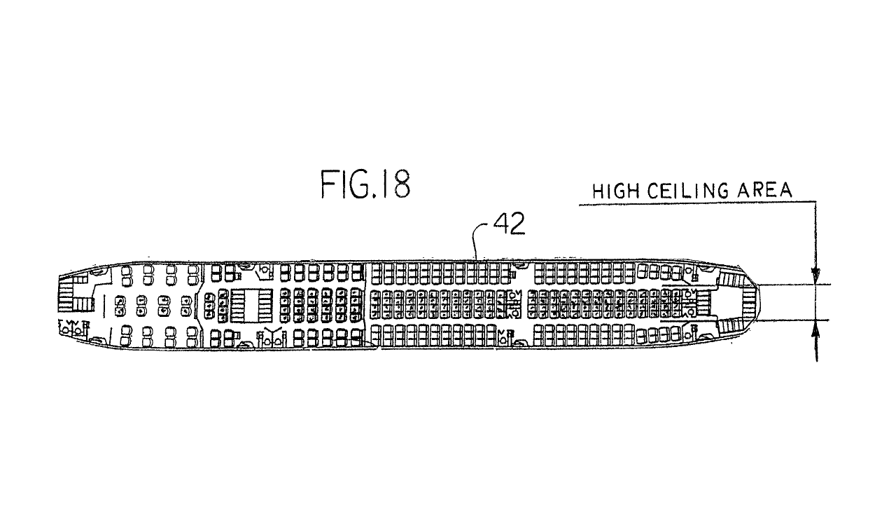

FIG. 17 shows a safety harness for sleeping person 31, with a right arm ring 32, with a left arm ring 33 and with a main belt 34. There are also visible clamps 35, a buckle 38, and an insert tongue 39. Wavy parts 40 of the belt 34 are left as a reserve for a movement of a sleeping person. Belt ends 41 will be permanently attached to sides of a back rest. User of this harness will place his or hers arms inside of the proper rings and will lock the buckle with insert on his or hers chest, before going to sleep.

FIG. 18 shows a plan view of a 747 aircraft 42 with a seating arrangement. Seats in the high ceiling area marked with dots could be easily converted to convertible seats and sleeping berths of this invention.

I claim:

1. A sleeping system, comprising a convertible seat and sleeping berth raising and lowering to different elevations.

2. The sleeping system according to claim 1, including a jacking device, connected to said convertible seat and sleeping berth.

3. The sleeping system according to claim 2, including a ceiling support, connected to said convertible seat and sleeping berth.

4. The sleeping system according to claim 1, including a lifting device, connected to said convertible seat and sleeping berth.

5. The sleeping system according to claim 4, including a floor support, connected to said convertible seat and sleeping birth.

6. The sleeping system according to claim 4, including a guiding column, connected to said convertible seat and sleeping berth.

7. A layout arrangement, comprising a line, including a convertible seat and sleeping berth and a raising convertible seat and sleeping berth, said raising convertible seat and sleeping berth raising above and reclining over said convertible seat and sleeping berth.

8. The layout arrangement according to claim 7, including a plurality of said raising convertible seats and sleeping berths and a plurality of said convertible seats and sleeping berths, alternatively placed behind each other.

9. A safety harness for a sleeping person, comprising a main belt attachable on both ends to a sleeping berth; two arm rings, a right one and a left one, both attached to said main belt; a right belt attached to said right ring; a left belt attached to said left ring; said left belt and said right belt releasebly connected to each other.

10. The safety harness according to claim 9, wherein at least one of said left belt or said right belt is attached to a buckle, and an other one of said left belt or said right belt is attached to an insert tongue, and said buckle and said insert tongue lockingly connected.
